(19) United States
(12) Patent Application Publication
(10) Pub. No.: US 2025/0239402 A1
(43) Pub. Date: Jul. 24, 2025

(54) MULTILAYER CERAMIC ELECTRONIC DEVICE AND DIELECTRIC CERAMIC COMPOSITION

(71) Applicant: TAIYO YUDEN CO., LTD., Tokyo (JP)

(72) Inventors: Kazuki MISAWA, Takasaki-shi (JP); Keiichi HATANO, Takasaki-shi (JP); Yuji TSUSHIMA, Takasaki-shi (JP)

(21) Appl. No.: 19/012,133

(22) Filed: Jan. 7, 2025

(30) Foreign Application Priority Data
Jan. 23, 2024 (JP) 2024-008159

(51) Int. Cl. H01G 4/12; C04B 35/468; C04B 37/00; H01G 4/30

(52) U.S. Cl. CPC H01G 4/1227; C04B 35/4682; C04B 37/001; H01G 4/1236; H01G 4/30; C04B 2235/3236; C04B 2235/3255; C04B 2235/768; C04B 2235/85; C04B 2237/346; C04B 2237/68

(57) ABSTRACT

A multilayer ceramic electronic device includes a dielectric layer that has a dielectric grain which includes a core portion, a shell portion surrounding the core portion and including a rare earth element, and an oxide segregated inside the shell portion and having a higher concentration of the rare earth element than the shell portion, and has a perovskite structure expressed by a general formula ABO₃, a plurality of internal electrode layers that sandwich the dielectric layer and face each other, and a plurality of external electrodes each of which is electrically coupled to each of the plurality of internal electrode layers.

### CROSS-REFERENCE TO RELATED APPLICATION

This application is based upon and claims the benefit of priority of the prior Japanese Patent Application No. 2024-008159, filed on Jan. 23, 2024, the entire contents of which are incorporated herein by reference.

### FIELD

A certain aspect of the present disclosure relates to a multilayer ceramic electronic device and a dielectric ceramic composition.

### BACKGROUND

In high-frequency communication systems such as mobile phones, multilayer ceramic electronic components such as multilayer ceramic capacitors (MLCCs) are used to eliminate noise.

### SUMMARY OF THE INVENTION

According to an aspect of the embodiments, there is provided a multilayer ceramic electronic device including: a dielectric layer that has a dielectric grain which includes a core portion, a shell portion surrounding the core portion and including a rare earth element, and an oxide segregated inside the shell portion and having a higher concentration of the rare earth element than the shell portion, and has a perovskite structure expressed by a general formula ABO₃; a plurality of internal electrode layers that sandwich the dielectric layer and face each other; and a plurality of external electrodes each of which is electrically coupled to each of the plurality of internal electrode layers.

According to another aspect of the embodiments, there is provided a dielectric ceramic composition including: a dielectric grain which includes a core portion, a shell portion surrounding the core portion and including a rare earth element, and an oxide segregated inside the shell portion and having a higher concentration of the rare earth element than the shell portion, and has a perovskite structure expressed by a general formula ABO₃.

### BRIEF DESCRIPTION OF THE DRAWINGS

FIG. 1 illustrates a dielectric ceramic composition according to a first embodiment;

FIG. 2 illustrates a unit lattice;

FIG. 3 illustrates a method for confirming a core-shell structure;

FIG. 4A to FIG. 4E illustrate a form of oxides;

FIG. 5 illustrates a perspective view of a multilayer ceramic capacitor, in which a cross section of a part of the multilayer ceramic capacitor is illustrated;

FIG. 6 is a cross-sectional view taken along line A-A in FIG. 5;

FIG. 7 is a cross-sectional view taken along line B-B in FIG. 5;

FIG. 8 illustrates a manufacturing method of a multilayer ceramic capacitor;

FIG. 9A and FIG. 9B illustrate a forming process of an internal electrode;

FIG. 10 illustrates a crimping process; and

FIG. 11 illustrates a case where a side margin section.

### DETAILED DESCRIPTION

In recent years, the use of multilayer ceramic electronic devices has expanded, even in electronic circuits that affect human life, such as in-vehicle electronic control devices. High reliability is required, and at the same time, higher mass production is required in terms of supply volume.

The dielectric ceramic composition used in the dielectric layer of multilayer ceramic electronic devices uses a sintered body with a core-shell structure in which barium titanate is used as the core and is surrounded by a shell in which various additives are solid-solved. With this structure, it is possible to transition the large electrostatic capacity near the Curie temperature, which exists around 125° C. and where barium titanate changes from the ferroelectric phase to the paraelectric phase, to a lower temperature in the shell portion due to the effect of various additives. Therefore, it is possible to design a device that can increase the electrostatic capacity in the practical temperature range around room temperature.

The core-shell structure is thought to be created by solid-solving various additives in barium titanate. The core-shell structure is believed to be formed by the reaction of various additives added to the barium titanate particles, the main component, in the firing temperature range of, for example, 1000° C. to 1400° C. In general, as the firing temperature increases, the various additives are solid-solved, and the shell portion becomes thicker. Therefore, in order to keep the electrostatic capacity of the multilayer ceramic electronic device within the required range, it is necessary to precisely control the solid-solution of the various additives.

For example, Japanese Patent Application Publication No. 2016-124779 and Japanese Patent Application Publication No. 2011-210783 disclose a dielectric ceramic composition, a dielectric material, and a multilayer ceramic capacitor containing the same, which contain a barium titanate-based main component and a subcomponent, and in which the relative intensity of the pyrochlore phase containing rare earth elements is controlled in an XRD analysis after sintering.

In recent years, the applications of dielectric ceramic compositions and multilayer ceramic electronic devices have expanded, and therefore higher mass productivity is required. For this purpose, it is necessary to suppress the change in electrostatic capacity due to the firing temperature and reduce the fluctuation in electrostatic capacity due to temperature.

Hereinafter, an exemplary embodiment will be described with reference to the accompanying drawings.

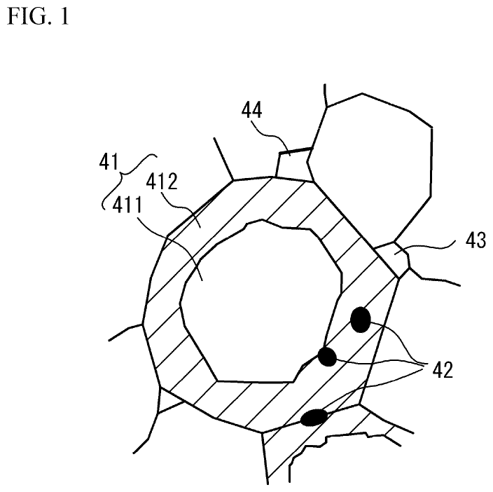

(First Embodiment) A dielectric ceramic composition according to a first embodiment is a ceramic polycrystalline body including crystal grains having a perovskite structure represented by the general formula ABO3, as illustrated in FIG. 1. At least one of these ceramic polycrystalline grains is a dielectric grain 41 having a core-shell structure.

The dielectric grain 41 has a roughly spherical core portion 411 and a shell portion 412 that surrounds and covers the core portion 411. The core portion 411 is a crystalline portion in which the additive compound is not dissolved or in which the amount of the additive compound dissolved is small. The shell portion 412 is a crystalline portion in which the additive compound is dissolved and has a higher additive compound concentration than the additive compound concentration of the core portion 411. In this embodiment, the shell portion 412 contains a rare earth element R. The rare earth element R is not particularly limited, but may be lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), or the like. The element concentration of the rare earth element R in the shell portion 412 is greater than the element concentration of the rare earth element in the core portion 411.

In the shell portion 412, oxides 42 having a higher concentration of the rare earth element R than in the shell portion 412 are segregated. The number of the oxides 42 is not particularly limited. However, in a cross section, the cross-sectional area of the shell portion 412 is greater than the total cross-sectional area of the oxides 42.

The dielectric ceramic composition of this embodiment contains the dielectric grain 41 and the oxide 42, and as a result has high insulating properties and can suppress variations in electrostatic capacity to firing temperature.

For example, when a cross section of the dielectric ceramic composition is observed in a field where a total of 100 or more dielectric grains 41 and the oxides 42 can be confirmed, the area ratio of the dielectric grains 41 is 95% or more and 99.95% or less, and the area ratio of the oxides 42 is 0.01% or more and 5% or less.

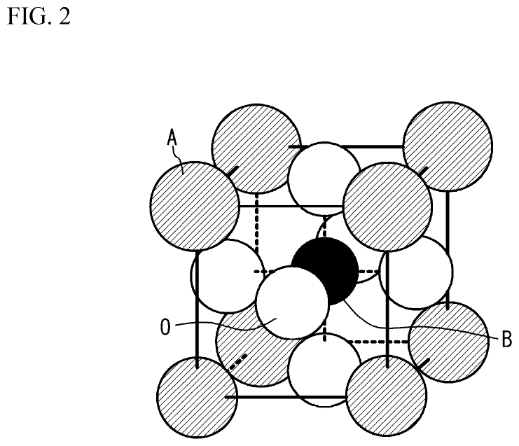

Crystal grains having a perovskite structure, which are the main component of the dielectric grain 41, has a unit cell as illustrated in FIG. 2. This unit cell has an A site located at the apex of the lattice, an O site located at the face center of the lattice, and a B site located within an octahedron with the O site as the apex. In the perovskite structure, alkaline earth metals that can take divalent cations such as barium (Ba), strontium (Sr), or calcium (Ca) are located at the A site, and hafnium (Hf) or zirconium (Zr), or titanium (Ti) that can take tetravalent cations are located at the B site.

The perovskite structure also allows a composition formula that deviates from the stoichiometric composition. That is, the ratio of the A-site element to the B-site element does not necessarily have to be 1:1, and defects may be generated within a range where the perovskite structure can be maintained. Furthermore, defects may also be generated regarding oxygen. For example, when the composition formula is A_{α}BO_{3-β}, compositions in the ranges of 0.98≤α≤1.01 and 0≤β≤0.20 are allowed.

However, due to the generation of oxygen vacancy, for example, the resistivity decreases and ionic conductivity is exhibited, which reduces the electrical life when used as a multilayer ceramic capacitor and increases the dielectric loss. For this reason, the dielectric grain 41 having a perovskite structure may contain at least one of first transition elements scandium (Sc), titanium (Ti), vanadium (V), chromium (Cr), manganese (Mn), iron (Fe), cobalt (Co), nickel (Ni), copper (Cu), or zinc (Zn). This makes it possible to improve resistivity, increase electrical life, and reduce dielectric loss due to electrostatic capacity.

The dielectric grain 41 may also contain at least one of second transition elements yttrium (Y), zirconium (Zr), niobium (Nb), molybdenum (Mo), ruthenium (Ru), rhodium (Rh), palladium (Pd), or silver (Ag) as necessary. This can improve resistivity, increase electrical life, and reduce dielectric loss relative to electrostatic capacity.

The dielectric grain 41 may also contain at least one of third transition elements lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), or gold (Au), as necessary. This can improve resistivity, increase electrical life, and reduce dielectric loss relative to electrostatic capacity.

The dielectric ceramic composition is preferably added with an additive containing a rare earth element R, such as lanthanum (La), cerium (Ce), praseodymium (Pr), neodymium (Nd), promethium (Pm), samarium (Sm), europium (Eu), gadolinium (Gd), terbium (Tb), dysprosium (Dy), or holmium (Ho). The dielectric ceramic composition is also preferably added with an additive containing titanium so that the element ratio (ratio of the number of elements) of titanium to the rare earth element R is 1 or more. Compared to a case where an additive containing titanium is not added, the solid solution reaction with barium titanate crystal particles is relatively suppressed. This effect makes it possible to achieve firing in a shorter time while suppressing the rate of change in electrostatic capacity due to changes in firing temperature, and to obtain high mass productivity.

Preferred additives containing the above rare earth element R include lanthanum oxide (La₂O₃), cerium oxide (Ce₂O₃), praseodymium oxide (Pr₂O₃), neodymium oxide (Nd₂O₃), promethium oxide (Pm₂O₃), samarium oxide (Sm₂O₃), europium oxide (Eu₂O₃), gadolinium oxide (Gd₂O₃), terbium oxide (Tb₂O₃), dysprosium oxide (Dy₂O₃), or holmium oxide (Ho₂O₃).

Preferred additives containing the above titanium include titanium oxide, however titanium hydroxide (Ti(OH)₄), titanium chloride (TiCl₄), titanium carbide (TiC), and titanium sulfide (TiS₂), or the like can also be used.

The additional material containing the rare earth element R and titanium is such as La₂Ti₂O₇, Ce₂Ti₂O₇, Pr₂Ti₂O₇, Nd₂Ti₂O₇, Pm₂Ti₂O₇, Sm₂Ti₂O₇, Eu₂Ti₂O₇, Gd₂Ti₂O₇, Tb₂Ti₂O₇, Dy₂Ti₂O₇, or Ho₂Ti₂O₇.

In addition to the addition of the rare earth element R to the dielectric ceramic composition, it is preferable to add 0.2 mol or more and 5.0 mol or less of manganese oxide (MnO) to 100 mol of barium titanate so that the Mn/Ti element ratio z, which is the number of the manganese element ratio to the number of titanium element, is 0.002≤z≤0.05.

In general, in a core-shell structure, as the sintering temperature increases, various additives tend to dissolve in greater amounts in the crystal grains made of barium titanate, resulting in a thicker shell. In the shell portion, the large electrostatic capacity range near 125° C., which is close to the Curie temperature of barium titanate, approaches room temperature. As a result, the electrostatic capacity in the practical temperature range near room temperature varies greatly depending on the thickness of the shell portion. Therefore, as an example, in order to keep the electrostatic capacity of a multilayer ceramic capacitor within a desired range, it is preferable to precisely control the sintering temperature.

For example, the dielectric ceramic composition according to this embodiment can be obtained by maintaining the temperature at 900° C. to 1100° C., then firing at 1150° C. to 1300° C., and by rapidly increasing the temperature during the firing process with a rate of 3000° C./h to 10000° C./h.

The dielectric grains 41 having a core-shell structure in which the shell portion 412 containing a rare earth element is formed has a different formation process from that of conventional core-shell structures. Specifically, not only is the rare earth element R solid-solved in the crystal grains made of barium titanate, but the added rare earth element R and titanium form compounds such as R₂Ti₂O₇, which is a compound with a pyrochlore structure or perovskite slab structure, and then react with the surface of the barium titanate crystal grains to form the shell portion 412 in the form of a composite perovskite compound such as R(Ti,Mn)O₃. This suppresses excessive solid solution reaction of the rare earth element R in the shell portion 412, and suppresses the rate of change in electrostatic capacity due to changes in the firing temperature. As a trace of the process of generating the shell portion 412, an oxide region with a higher concentration of the rare earth element R than the shell portion is generated. The reaction of generating R₂Ti₂O₇ occurs between 900° C. and 1100° C.

In order to promote this shell generation reaction, it is preferable that the rare earth element R is an element that is easily solid-solved in the A site of ABO₃. Specifically, it is preferable that the rare earth element R is such as lanthanum (La), cerium (Ce), praseodymium (Pr), neodymium (Nd), promethium (Pm), samarium (Sm), europium (Eu), gadolinium (Gd), terbium (Tb), dysprosium (Dy), or holmium (Ho), which has a larger ionic radius than erbium (Er).

On the other hand, if a rare earth element R (erbium, thulium, ytterbium, ruthenium) with an ionic radius smaller than that of holmium is used, a compound with a pyrochlore structure R₂Ti₂O₇ is generated, but the shell-forming reaction between R₂Ti₂O₇ and the barium titanate crystal grains does not proceed sufficiently, and there is a risk that the cores of multiple grains may come into electrical contact with the oxide region. As a result, the resistivity decreases, and the compound may become unsuitable for use in multilayer ceramic capacitors.

According to Yukikuni AKISHIGE and Misako KAMATA, “Crystal Chemistry of A₂B₂O₇ Type Oxide Ferroelectrics with Perovskite-related Layered Structure”, Memoirs of the Faculty of Education, Shimane University, Natural science, the smaller the ionic radius of the rare earth element R in R₂Ti₂O₇ is, the more stable the pyrochlore structure becomes. Therefore, in order to promote the shell production reaction, it is preferable to use a rare earth element having a larger ionic radius than erbium (Er), such as lanthanum (La), cerium (Ce), praseodymium (Pr), neodymium (Nd), promethium (Pm), samarium (Sm), europium (Eu), gadolinium (Gd), terbium (Tb), dysprosium (Dy), or holmium (Ho).

In the shell portion 412, the further added magnesium may react on the surface of the barium titanate crystal grains to produce a composite perovskite compound such as R(Mg, Ti, Mn)O₃.

The composite perovskite compound, which is considered to be R(Ti,Mn)O₃ or R(Mg,Ti,Mn)O₃, may react with the surrounding barium titanate crystal grain, which is the main component, to produce (R,Ba)(Ti,Mn)O₃ or (R,Ba)(Mg,Ti,Mn)O₃ as the shell portion 412.

For example, the core portion 411 in the core-shell structure is mainly composed of crystal grains made of barium titanate, but may also contain an added rare earth element, manganese, magnesium, or the like. However, it is sufficient that the shell portion 412 contains relatively more of the rare earth element, manganese, magnesium, or the like, among the additives, than the core portion 411.

More specifically, a crystal grain having a core-shell structure in which a shell containing rare an earth element and manganese is formed with a crystal grain made of barium titanate as the main component may contain a relatively large amount of rare earth element or manganese compared to the element ratio to titanium at the center at any point within a range of 10% of the diameter of the crystal grain from the surface to the center. The presence of such crystal grains having a core-shell structure not only suppresses the change in electrostatic capacity held by the polycrystalline body that constitutes the dielectric ceramic composition due to changes in firing temperature, but also suppresses the movement of oxygen vacancies at the grain boundaries and inside the shell portion, suppressing a decrease in resistivity and improving electrical life.

The average grain size of the dielectric grains 41 in the dielectric ceramic composition is within the range of 50 nm to 500 nm, and large grains of 3 μm or more are not retained in the area where they are electrically utilized as a dielectric. For example, in the dielectric ceramic composition, the maximum grain size of the dielectric grains 41 is preferably 2 μm or less. In addition, in view of the general ceramics characteristic that the distribution of the grain size and composition of the contained crystal grains falls within a relatively narrow range, if it can be confirmed that the dielectric grains 41 have a core-shell structure, it can be said that the presence of many dielectric grains 41 having a similar structure has a favorable effect on the electrical life of the dielectric ceramic composition.

The grain size of the dielectric grains 41 can be measured by the following procedure. The dielectric ceramic composition having the dielectric grains 41 is cut or polished to expose the observation surface. This exposure method is not particularly limited, and a method of cutting or polishing the element can be adopted. At this time, in order to fully observe the internal ceramic structure, it is preferable to finally use a diamond paste of 2 μm or less to obtain a smoothness that can be judged as a mirror surface. Next, after depositing a conductive material such as platinum or osmium on the observation surface, the surface is observed with a scanning electron microscope (SEM) and a photograph of the dielectric grains 41 is taken. Next, a plurality of parallel straight lines are drawn in the photograph, and the length of each line segment cut at the periphery of each dielectric grain 41 (the distance between two points where each straight line intersects with the periphery of the dielectric grain 41) is taken as the grain diameter (grain size) of the dielectric grains 41. In this method, the grain size of the dielectric grains 41 is measured for 400 or more grains, and the average of the results obtained is taken as the average grain size of the dielectric grains 41. In addition, if the contour of the dielectric grains 41 is difficult to see in the exposed ceramics, it is advisable to perform a heat treatment (thermal etching) for about 5 minutes on the exposed ceramics at a temperature about 50° C. lower than the firing temperature prior to deposition of platinum or osmium. Instead of this heat treatment, it is also possible to perform chemical etching using hydrofluoric acid, hydrochloric acid, sulfuric acid, nitric acid, or a mixture of these acids at an appropriate concentration for etching.

The presence of the dielectric grains 41 having a core-shell structure in the dielectric ceramic composition can be confirmed by the following procedure. Note that the following procedure explains the case where gadolinium is used as the rare earth element as an example.

First, a sample for observation with a transmission electron microscope (TEM) is cut out from the dielectric ceramic composition to be confirmed. This cutting can be performed using a focused ion beam (FIB) device or the like.

Then, the cut-out sample for TEM observation is observed with a TEM equipped with an energy dispersive X-ray spectrometry (EDS) or wavelength dispersive X-ray spectrometry (WDS) to determine the crystal grain to be measured and to identify the outer periphery shape of the grain.

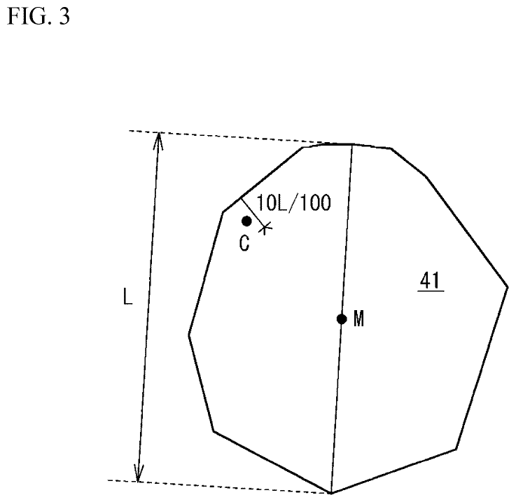

Next, as illustrated in FIG. 3, the longest line segment connecting any two points located on the outer periphery of the crystal grain to be measured is determined, and the length L of the line segment is measured. This length L is then regarded as the diameter of the crystal grain to be measured. The midpoint M of the line segment is also determined from the length of the line segment obtained.

A composition analysis is performed by EDS or WDS for any point C on the periphery within a range of 10% of the diameter of the crystal grain, that is, 10 L/100, from both ends of the line segment, to calculate the elemental abundance ratio between the element being analyzed and titanium. In the composition analysis, for example in EDS measurement, the elemental abundance ratio can be determined by the titanium K-line intensity with respect to the barium K-line or L-line, calcium K-line, gadolinium L-line, manganese K-line, and magnesium K-line. More specifically, from these intensities, a correction (ZAF correction) is performed that takes into account the atomic number effect, absorption effect, and fluorescence excitation effect, and the ratio of each element with respect to the titanium element content is calculated, which is the ratio of each element to titanium in the shell portion 412. A composition analysis is also performed in the same way for the midpoint M of the line segment, and the ratio is calculated, which is the ratio of each element to titanium in the core portion 411.

Next, the ratio of each element to titanium in the shell portion 412 is compared with the ratio of each element to titanium in the core portion 411. If the ratio in the shell portion 412 is higher than that in the core portion 411, it is determined that the dielectric grain 41 being measured has a core-shell structure.

As described above, the dielectric ceramic composition holds, in addition to the dielectric grains 41, at least one oxide having a higher concentration of the rare earth element R than the shell portion 412 as the oxide 42. The element ratio of the rare earth element R in the oxide 42 is 0.20 or more higher than the B site of the perovskite constituting the dielectric grains 41.

The oxide 42 is, for example, an oxide in which barium derived from barium titanate is diffused into a compound having a pyrochlore structure. As described above, in the dielectric ceramic composition according to this embodiment, the oxide 42 is an oxide generated secondarily because the shell portion 412 is generated in the form of a composite perovskite compound thought to be R(Ti,Mn)O₃, R(Mg,Ti,Mn)O₃, (R,Ba)(Ti,Mn)O₃, (R,Ba)(Mg,Ti,Mn)O₃ or the like through an intermediate product such as R₂Ti₂O₇. By intentionally precipitating the oxide 42, the dielectric grains 41 can be obtained, and the change in electrostatic capacity caused by the change in firing temperature can be suppressed, making it possible to achieve high mass productivity, for example, in a multilayer ceramic capacitor, which is required to be highly mass-producible.

The fact that the dielectric ceramic composition contains the oxide 42 having a higher concentration of the rare earth element R than the shell portion 412 can be confirmed by the same method as that used to confirm the presence of the dielectric grains 41 having the core-shell structure described above.

When the element ratio of the rare earth element R to the B site of the perovskite constituting the dielectric grain obtained by the above method is 0.20 or more higher, the crystal grain is determined to be the oxide 42. In this case, when an SEM is used for observation, the oxide 42 is characterized in that it is observed to have a relatively high brightness and is brighter than the shell portion 412 in observation by a backscattered electron image (BSE image).

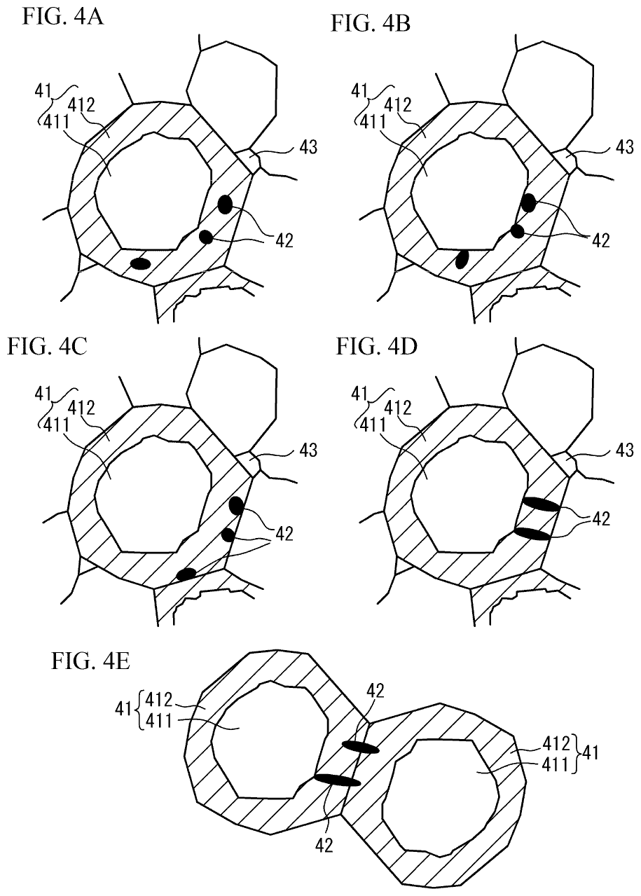

Note that, as illustrated in FIG. 4A, the oxide 42 may be enclosed inside the shell portion 412. Specifically, the oxide 42 is not in contact with the core portion 411, and is not in contact with the grain boundary of the dielectric grain 41. Alternatively, as illustrated in FIG. 4B, the oxide 42 may be in contact with a part of the core portion 411 at the interface between the core portion 411 and the shell portion 412. Alternatively, as illustrated in FIG. 4C, the oxide 42 may be in contact with a part of the grain boundary of the dielectric grain 41.

Alternatively, as illustrated in FIG. 4D, the oxide 42 may extend from a part of the core portion 411 at the interface between the core portion 411 and the shell portion 412 to a part of the grain boundary of the dielectric grain 41. Also, as illustrated in FIG. 4A to FIG. 4D, a plurality of the oxides 42 may be present in the shell portion 412, being spaced apart from each other. Note that, as illustrated in FIG. 4E, the oxide 42 may be formed across a plurality of the adjacent dielectric grains 41 via the grain boundary, but the oxide 42 is present so as not to connect the core portions 411 of the plurality of the dielectric grains 41. The oxides 42 of the forms described in FIG. 4A to FIG. 4E may be mixed.

Furthermore, as illustrated in FIG. 1, the dielectric ceramic composition may contain a crystal grain 43 having a different composition or crystal structure from the dielectric grains 41 and the oxide 42. The dielectric ceramic composition may also contain crystal grains or glass particles containing silicon. This allows the dielectric ceramic composition to be sufficiently densified by firing at 1300° C. or less.

The crystal grain 43 may be a crystal grain or a glass grain such as silicate (SiO₂), enstatite (MgSiO₃), barium magnesium silicate (BaMgSiO4), or fresnoite (Ba₂TiSi₂O₈).

Other examples of the crystal grain 43 may be a secondary compound derived from added substances or electrodes, such as geikierite (MgTiO₃), manganese nickel oxide ((Mn,Ni)O), or pyrophanite (MnTiO₃).

Furthermore, a heterophase 44 having a different composition or crystal structure which is different from that of the dielectric grain 41, the oxide 42, and the crystal grain 43 may be included in the dielectric ceramic composition.

A more suitable example of the heterophase 44 is a barium titanate-based composite oxide, such as Ba₄Ti₁₁O₂₆, which is a monoclinic crystal system having space group C2/m and lattice constants a=15.160 Å, b=3.893 Å, c=9.093 Å, and β=98.6°. This is because the barium titanate-based composite oxide has a barium to titanium ratio relatively close to 3, and can be easily precipitated intentionally without using a large amount of an additive containing titanium as the main component. For information on the crystal phase of Ba₄Ti₁₁O₂₆ as a suitable example, PDF-01-083-1459 in the Powder Diffraction File (PDF) issued by ICDD (International Centre for Diffraction Data; Pennsylvania, USA) can be referenced.

As a more suitable example of the heterophase 44, it is desirable that magnesium, manganese, or nickel is solid-solved in Ba₄Ti₁₁O₂₆ and occupy the vacancy sites or substitute for some of the titanium. Ba₄Ti₁₁O₂₆ has a crystal structure in which vacancies occur at some of the titanium sites. Therefore, titanium is likely to change from a tetravalent cation to a trivalent cation at the vacancy sites, and as a result, the resistivity is likely to decrease. To complement this, it is effective to incorporate at least one of magnesium, manganese, and nickel into the alloy as a solid solution.

(Second Embodiment) In a second embodiment, a multilayer ceramic capacitor 100 using the dielectric ceramic composition of the first embodiment will be described.

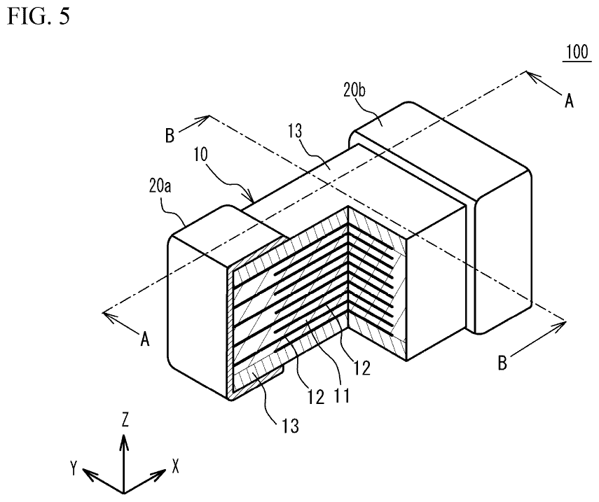

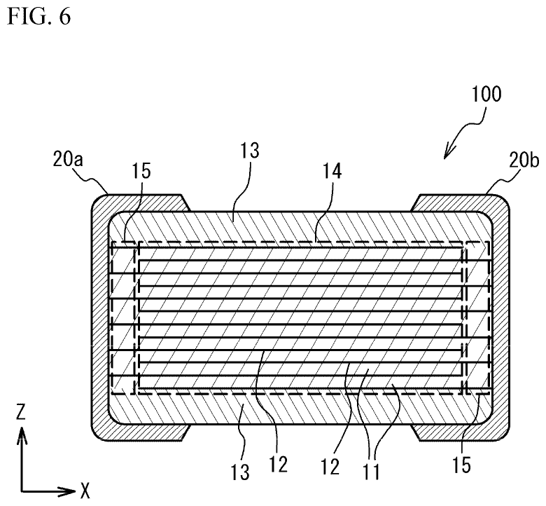

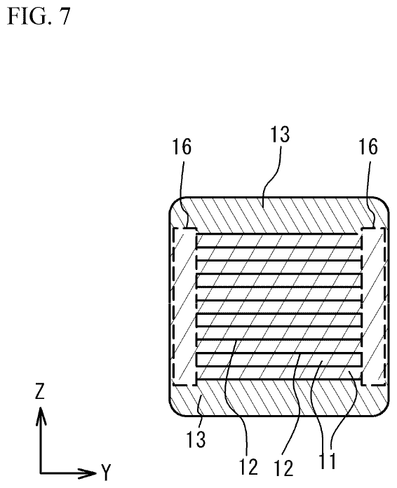

FIG. 5 illustrates a perspective view of the multilayer ceramic capacitor 100, in which a cross section of a part of the multilayer ceramic capacitor 100 is illustrated. FIG. 6 is a cross-sectional view taken along line A-A in FIG. 5. FIG. 7 is a cross-sectional view taken along line B-B in FIG. 5. As illustrated in FIG. 5 to FIG. 7, the multilayer ceramic capacitor 100 includes a multilayer chip 10 having a rectangular parallelepiped shape, and external electrodes 20a and 20b that are respectively provided on two end faces of the multilayer chip 10 opposite to each other. Among four faces other than the two end faces of the multilayer chip 10, two faces other than the top face and the bottom face in the stack direction are referred to as side faces. Each of the external electrodes 20a and 20b extends to the top face and the bottom face in the stack direction and the two side faces of the multilayer chip 10. However, the external electrodes 20a and 20b are spaced from each other.

The multilayer chip 10 has a structure in which dielectric layers 11 containing the dielectric ceramic composition and internal electrode layers 12 mainly composed of a base metal are alternately stacked. In other words, the multilayer chip 10 includes the internal electrode layers 12 facing each other and the dielectric layers 11 sandwiched between the internal electrode layers 12. The edges in the direction in which each internal electrode layer 12 extends are alternately exposed at a first end face provided with the external electrode 20a of the multilayer chip 10 and a second end face provided with the external electrode 20b. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic

The internal electrode layer 12 is mainly composed of a base metal such as nickel (Ni), copper (Cu), or tin (Sn). The internal electrode layer 12 may be composed of a noble metal such as platinum (Pt), palladium (Pd), silver (Ag), or gold (Au) or alloy including one or more of them.

As illustrated in FIG. 6, the section where the internal electrode layer 12 connected to the external electrode 20a faces the internal electrode layer 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin section 15. The section where the internal electrode layers 12 connected to the external electrode 20b face each other with no internal electrode layer 12 connected to the external electrode 20a interposed therebetween is another end margin section 15. That is, the end margin section 15 is a section where the internal electrode layers 12 connected to one of the external electrodes face each other with no internal electrode layer 12 connected to the other of the external electrodes interposed therebetween. The end margin section 15 is a section where no capacity is generated.

As illustrated in FIG. 7, in the multilayer chip 10, a section from one of the two side faces of the multilayer chip 10 to lateral side edges of the internal electrode layers 12 is referred to as a side margin section 16. That is, each of the side margin sections 16 is a section that covers the lateral side edges, extending toward one of the side faces of the multilayer structure, of the stacked internal electrode layers 12. The side margin section 16 is a section where no capacity is generated.

In the multilayer ceramic capacitor 100 according to this embodiment, at least a portion of the dielectric layer 11 in the capacity section 14 contains the dielectric grain 41 and the oxide 42 illustrated in FIG. 1. This makes it possible to suppress the change in electrostatic capacity due to the firing temperature and to improve the insulating properties in a wide range of firing atmospheres, thereby enabling high mass productivity to be achieved.

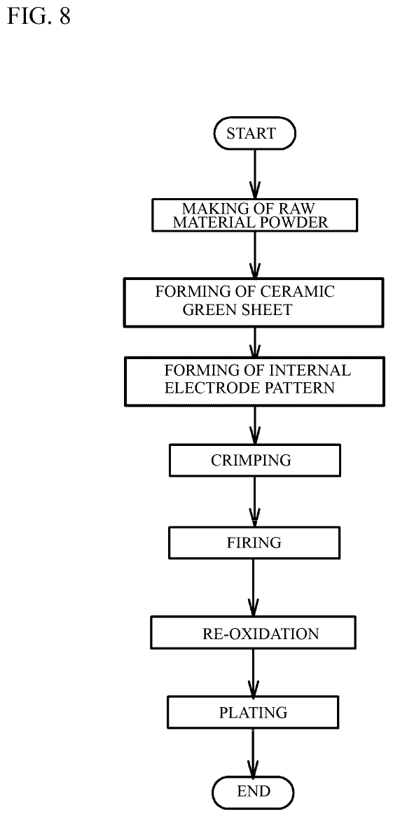

Next, a description will be given of a manufacturing method of the multilayer ceramic capacitors 100. FIG. 8 illustrates a manufacturing method of the multilayer ceramic capacitor 100.

(Making process of raw material powder) The dielectric ceramic composition for forming the dielectric layer 11 is prepared. Generally, an A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

An additive compound may be added to the resulting barium titanate powder, in accordance with purposes. As an example, the additive of the dielectric ceramic composition of the first embodiment is used. If necessary, an oxide or a glass containing Zr (zirconium), V (vanadium), Cr (chromium), Co (cobalt), Ni (nickel), Li (lithium), B (boron), Na (sodium), K (potassium) may also be used.

For example, a compound containing an additive compound is wet mixed with barium titanate powder, and then dried and pulverized to prepare a ceramic material in which barium titanate powder and the additive compound are mixed. For example, the ceramic material obtained as described above may be pulverized as necessary to adjust the particle size, or may be combined with a classification process to adjust the particle size. Specifically, the ceramic material may be mixed with beads of 0.1 mm to 3 mm in diameter, such as yttrium-stabilized zirconia, alumina, or silicon nitride, and stirred for 10 to 100 hours to adjust the particle size. The above process results in the dielectric ceramic composition.

(Forming of dielectric green sheet) Next, a binder such as polyvinyl butyral (PVB) resin, an organic solvent such as ethanol or toluene, and a plasticizer are added to the resulting dielectric material and wet-blended. With use of the resulting slurry, a ceramic green sheet 51 is formed on a base material by, for example, a die coater method or a doctor blade method, and then dried. The base material is, for example, PET (polyethylene terephthalate) film. Figures of forming of the dielectric green sheet is omitted.

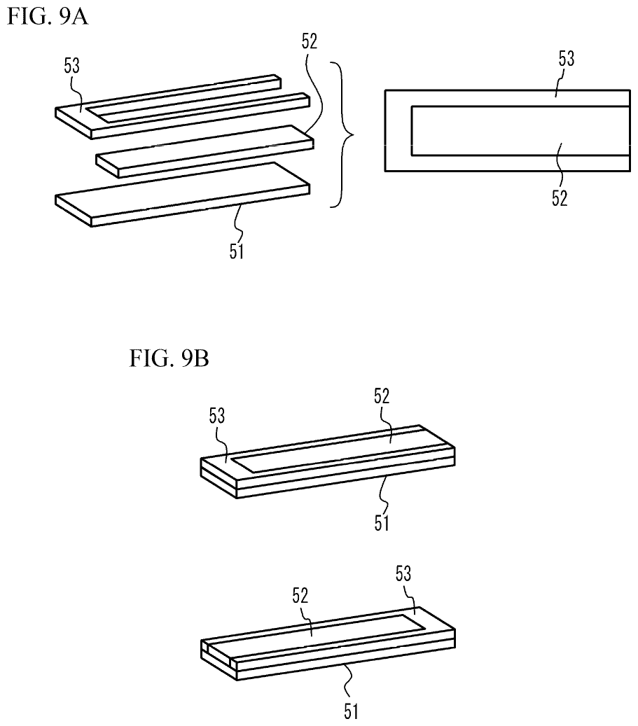

(Forming of internal electrode pattern) Next, as illustrated in FIG. 9A, a metal conductive paste containing an organic binder for forming internal electrodes is printed on the surface of the ceramic green sheet 51 by screen printing, gravure printing, or the like. Internal electrode patterns 52 are arranged alternately to a pair of external electrodes. Ceramic particles are added to the metal conductive paste as a co-material. Although the main component of the ceramic particles is not particularly limited, it is preferably the same as the main component ceramic of the dielectric layer 11. For example, barium calcium titanate having an average particle size of 50 nm or less may be uniformly dispersed.

Next, a binder such as ethyl cellulose and an organic solvent such as terpineol are added to the dielectric ceramic composition obtained in the raw material powder manufacturing process, and the mixture is kneaded in a roll mill to form a dielectric pattern paste for the reverse pattern layer. As illustrated in FIG. 9A, on the ceramic green sheet 51, a dielectric pattern 53 is arranged by printing a dielectric pattern paste in the peripheral area where the internal electrode pattern 52 is not printed, and a gap with the internal electrode pattern 52 is filled. The ceramic green sheet 51 on which the internal electrode pattern 52 and the dielectric pattern 53 are printed is referred to as a stack unit.

Thereafter, as illustrated in FIG. 9B, the internal electrode layers 12 and the dielectric layers 11 are arranged alternately, and the internal electrode layers 12 have edges on both longitudinal end surfaces of the dielectric layers 11. The stack units are stacked so that they are alternately exposed and drawn out alternately to a pair of the external electrodes 20a and 20b having different polarities. For example, the number of stacked layers of the internal electrode pattern 52 is set to 100 to 1000 layers.

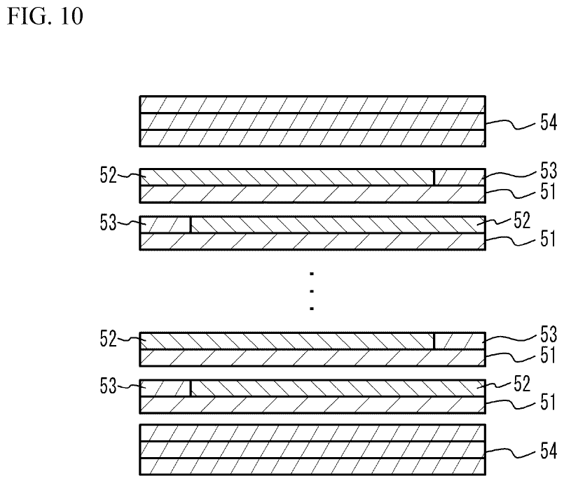

(Crimping Process) As illustrated in FIG. 10, a predetermined number (for example, 2 to 10 layers) of cover sheets 54 are stacked on top and bottom of the multilayer body in which the stack units are stacked and bonded by thermocompression. As an example of the ceramic material for the cover sheet 54, the dielectric ceramic composition described above can be used. Thereafter, the multilayer body is cut into a predetermined chip size (for example, 1.0 mm×0.5 mm).

(Firing process) After de-binding the ceramic multilayer body thus obtained in an N₂ atmosphere, air atmosphere or the like, a metal paste that will become the base layer of the external electrodes 20a and 20b is applied by a dip method, and the ceramic multilayer body held in a reductive atmosphere under an oxygen partial pressure of 10⁻¹⁰ to 10⁻⁷ atm, 800° C. to 1100° C. and is fired at 1150° C. to 1300° C. for 10 minutes to 2 hours. In this way, the multilayer ceramic capacitor 100 is obtained.

(Re-oxidation treatment process) Thereafter, re-oxidation treatment may be performed at 600° C. to 1000° C. in an N₂ gas atmosphere.

(Plating process) Thereafter, a metal coating such as Cu, Ni, Sn and so on is performed on the base layer of the external electrodes 20a and 20b by plating. Through the above steps, the multilayer ceramic capacitor 100 is completed.

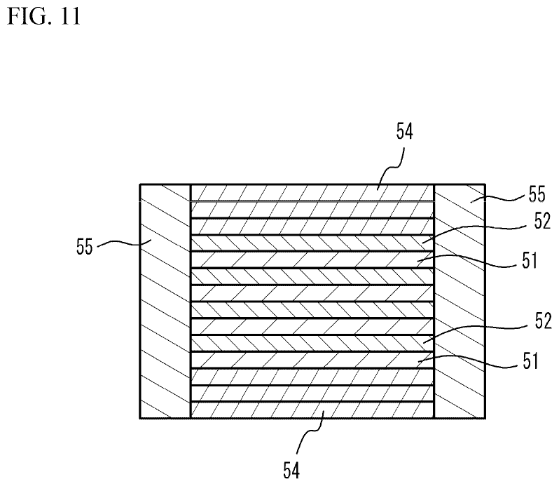

The side margin section may be attached or coated on the side surface of the ceramic multilayer body. Specifically, as illustrated in FIG. 11, the ceramic multilayer body is obtained by alternately stacking the ceramic green sheets 51 and the internal electrode patterns 52 having the same width as the ceramic green sheets 51. Next, a sheet formed of the dielectric pattern paste may be attached as a side margin section 55 to the side surface of the ceramic multilayer body.

According to the manufacturing method of this embodiment, the added rare earth element R and titanium are kept at 800 to 1100° C. for 10 minutes to 1 hour in a reducing atmosphere with an oxygen partial pressure of 10⁻¹⁰ to 10⁻⁷ atm, and then the added rare earth element R and titanium generate R₂Ti₂O₇, which is a compound with a pyrochlore structure or a perovskite slab structure. When the temperature is then raised to 1100° C. to 1300° C., the R₂Ti₂O₇ reacts with the surface of the barium titanate crystal grains, and generates the shell portion 412 in the form of a composite perovskite compound such as R (Ti, Mn)O₃. Since the dielectric grain 41 and the oxide 42 illustrated in FIG. 1 are formed in at least a part of the dielectric layer 11 in the capacity section 14, the change in electrostatic capacity due to the firing temperature can be suppressed. As a result, it is possible to obtain high mass productivity.

The firing temperature dependency (Δε/° C.) of the relative dielectric constant due to the change in firing temperature of the multilayer ceramic capacitor 100 is determined by the following method. First, the electrostatic capacity Cp (nF) and DC current I (nA) of the multilayer ceramic capacitor 100 that has been through the firing process, reoxidation process, and plating process are measured. Next, the capacity section 14 of the multilayer ceramic capacitor 100 is exposed by cutting or polishing the cross section of line A-A and the cross section of line B-B illustrated in FIG. 6 and FIG. 7, and the effective area of the internal electrode layer is calculated in a state where a smoothness that can be judged as a mirror surface is obtained using a diamond paste of 2 μm or less.

The effective area S is calculated according to S=L×W×(N−1) from the length L and number of layers N of the internal electrode layer 12 in the capacity section 14 in FIG. 6, and the width W of the internal electrode layer 12 in the capacity section 14 in FIG. 7.

Each thickness of the dielectric layers 11 is also measured at this time, and the average thickness “t” is calculated. In this case, the relative dielectric constant “ε” can be calculated according to ε=(Cp×t/S)/ε0, and the dielectric constant of a vacuum: ε₀=8.8542×10⁻¹² F/m.

Furthermore, the DC resistivity ρ(Ω·cm) can be calculated according to ρ=(V/I)×(S/t), where V (V) is the DC voltage during measurement.

Regarding the electrostatic capacity Cp, it is generally preferable to measure it using an LCR meter. When measuring, it is necessary to determine the measurement frequency and measurement voltage, and it is preferable to determine the measurement voltage as a measurement electric field that depends on the thickness of the dielectric layer 11. In this embodiment, the electrostatic capacity Cp can be measured at a room temperature of 25° C., with a measurement frequency of 1 kHz and a measurement electric field of 0.5 Vrms/μm, that is, 1 Vrms when the thickness of the dielectric layer 11 is 2 μm.

The DC current I is generally preferably measured using an insulation resistance meter. When making the measurement, it is necessary to determine the measurement voltage, and it is preferable to determine it as a measurement electric field that depends on the thickness of the dielectric layer 11. In this embodiment, the multilayer ceramic capacitor 100 is held in a thermostatic chamber at 150° C. for 30 minutes, insulation from the surroundings is ensured using ceramic insulators or the like, and a measurement electric field of 30 V/μm (for example, 60 V for 30 seconds when the thickness of the dielectric layer 11 is 2 μm) is applied through wires connected from the thermostatic chamber to the external electrodes 20a and 20b, the DC current I is measured, and the DC resistivity p can be calculated. Note that, unless otherwise specified, the measurement is performed in accordance with Japan Industrial Standards C5101-22:2021, Fixed Capacitors for Electronic Equipment—Part 22: General Rules by Type—Fixed Multilayer Ceramic Capacitors for Surface Mount Type 2.

Next, the DC resistivity “ρ” is measured for the multilayer ceramic capacitor obtained at each firing temperature, and the firing temperature that maintains the highest resistivity is determined as the optimal firing temperature. In general, if the firing temperature is too low, the density becomes low and the resistivity becomes low, and if the firing temperature is too high, the ceramic grains become large and the number of grain boundaries decreases, resulting in a decrease in resistivity.

Next, the relative dielectric constant “ε” of the multilayer ceramic capacitor obtained at the firing temperature that maintains the highest resistivity and the relative dielectric constant of the multilayer ceramic capacitor obtained by firing at firing temperatures of −20° C. and +20° C. from the firing temperature that maintains that highest resistivity are used to determine the slope of a straight line using the least squares method. And the value is used to determine the firing temperature dependency of the relative dielectric constant (Δε/° C.), which is used as an index of high mass productivity.

It is desirable that the DC resistivity measured at 150° C. is 1.0×10⁸ Ω·cm or more. By being 1.0×10⁸ Ω·cm or more, it is possible for the multilayer ceramic capacitor 100 using the dielectric ceramic composition of this embodiment to have sufficient resistance.

The direct current resistivity measured at 150° C. is more preferably 1.0×10¹⁰ Ω·cm or more. By being 1.0×1010 Ω·cm or more, not only does the multilayer ceramic capacitor 100 using the dielectric ceramic composition of this embodiment have sufficient resistance, but it also becomes easier to design the dielectric layer thinner and increase the number of stacked internal electrode layers.

It is preferable that Δε/° C. is 10 or less. When it is 10 or less, it is possible to achieve firing in a shorter time, while suppressing changes in electrostatic capacity due to changes in firing temperature, and to achieve high mass productivity in the multilayer ceramic capacitor 100 using the dielectric ceramic composition of this embodiment.

It is preferable that the relative dielectric constant “ε” is 2000 or more. Even if the DC resistivity measured at 150° C. is 2.0×10⁸ Ωcm or more and the firing temperature dependency of the dielectric constant Δε/° C. is 12 or less, if “ε” is small, the result is that the electrostatic capacity Cp will be an insufficient value, and the characteristics will be unsuitable for the application of the multilayer ceramic capacitor 100 using the dielectric ceramic composition.

Note that in the above embodiments, a multilayer ceramic capacitor has been described as an example of a multilayer ceramic electronic component, but this is not limiting. For example, other multilayer ceramic electronic components such as varistors and thermistors may also be used.

### EXAMPLES

(Example 1) Barium titanate (BaTiO₃) powder with an average particle size of 200 nm was prepared, and 0.75 mol of Gd₂O₃, 1.50 mol of TiO₂, 1.00 mol of MnCO₃, 1.00 mol of SiO₂, and 0.50 mol of MgO were added to 100 mol of the barium titanate powder to obtain a dielectric ceramic composition.

The dielectric ceramic composition was mixed with ethanol, toluene, and PVB (polyvinyl butyral) resin to prepare a dielectric slurry. This slurry was formed into a ceramic green sheet using a die coater. After drying this ceramic green sheet, nickel paste was printed on it to form an internal electrode pattern. The obtained stack units were stacked, and the top and bottom were pressed with layers of thickly stacked ceramic green sheets that did not form an internal electrode pattern, and then cut into small pieces. After that, Ni paste was dipped on the two end faces as a conductive paste for the external electrodes, and degreased in nitrogen gas. The degreased small pieces were fired and sintered in a reducing atmosphere in which the oxygen partial pressure was controlled so that nickel would not oxidize, to produce a multilayer ceramic capacitor. The firing was performed by maintaining the temperature at 1000° C. for 10 minutes, and then at 1240° C. for 10 minutes.

The size of the produced multilayer ceramic capacitor was 1005 shape (1.0 mm×1.0 mm×0.5 mm). Then, a re-oxidation process was performed at 950° C. Then, a plating process was performed to form a Cu-plated layer, a Ni-plated layer, and a Sn-plated layer on the surface of the base layer, and a multilayer ceramic capacitor was obtained. The average thickness of the dielectric layer 11 was 2.0 m.

(Example 2) In Example 2, 0.75 mol of La₂O₃, 1.50 mol of TiO₂, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes, and then at 1220° C. for 10 minutes. The other conditions were the same as in Example 1.

(Example 3) In Example 3, 0.75 mol of Pr₂O₃, 1.50 mol of TiO2, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes, and then at 1230° C. for 10 minutes. The other conditions were the same as in Example 1.

(Example 4) In Example 4, 0.75 mol of Nd₂O₃, 1.50 mol of TiO₂, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes, and then at 1230° C. for 10 minutes. The other conditions were the same as in Example 1.

(Example 5) In Example 5, 0.75 mol of Eu₂O₃, 1.50 mol of TiO₂, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes and then at 1240° C. for 10 minutes. The other conditions were the same as in Example 1.

(Example 6) To 100 mol of barium titanate powder, 0.75 mol of Dy₂O₃, 1.50 mol of TiO₂, 1.00 mol of MnCO₃, 1.00 mol of SiO₂, and 0.50 mol of MgO were added to obtain a dielectric ceramic composition. The firing temperature was maintained at 1000° C. for 10 minutes, and then at 1240° C. for 10 minutes. The other conditions were the same as in Example 1.

(Example 7) To 100 mol of barium titanate powder, 0.75 mol of Ho₂O₃, 1.50 mol of TiO₂, 1.00 mol of MnCO₃, 1.00 mol of SiO₂, and 0.50 mol of MgO were added to obtain a dielectric ceramic composition. The firing temperature was maintained at 1000° C. for 10 minutes, and then at 1250° C. for 10 minutes. The other conditions were the same as in Example 1.

(Example 8) 0.75 mol of Gd₂Ti₂O₇, 1.00 mol of MnCO₃, 1.00 mol of SiO₂, and 0.50 mol of MgO were added to 100 mol of barium titanate powder to obtain a dielectric ceramic composition. The firing temperature was maintained at 1240° C. for 10 minutes. Other conditions were the same as in Example 1.

(Example 9) In Example 9, 0.75 mol of Er₂O₃, 1.50 mol of TiO₂, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes, and then maintaining the temperature at 1270° C. for 10 minutes. The other conditions were the same as in Example 1.

(Example 10) In Example 10, 0.75 mol of Yb₂O₃, 1.50 mol of TiO2, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes and at 1270° C. for 10 minutes. The other conditions were the same as in Example 1.

(Comparative Example 1) In Comparative Example 1, 0.75 mol of Gd₂O₃, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes, and then at 1260° C. for 10 minutes. The other conditions were the same as in Example 1.

(Comparative Example 2) In Comparative Example 2, 0.75 mol of Gd₂O₃, 0.75 mol of TiO₂, 1.00 mol of MnCO₃, 1.00 mol of SiO₂, and 0.50 mol of MgO were added to 100 mol of barium titanate powder to obtain a dielectric ceramic composition. The firing was performed by maintaining the temperature at 1000° C. for 10 minutes, and then at 1250° C. for 10 minutes. The other conditions were the same as in Example 1.

For each of the multilayer ceramic capacitors of Examples 1 to 10 and Comparative Examples 1 and 2, the electrostatic capacity Cp was measured at room temperature (25° C.) at 1 kHz and 1 Vrms using an LCR meter, and the direct current “I” was measured at 150° C. when 60 V was applied for 30 seconds using an insulation resistance meter. In addition, the cross sections of lines A-A and B-B in FIG. 5 were exposed to calculate the effective area “S” of the internal electrode layer and the average thickness “t” of the dielectric layer. The relative dielectric constant “ε” and resistivity “ρ” were calculated from the effective area “S” and the average thickness “t”. The resistivity “ρ” of each of the multilayer ceramic capacitors of Examples 1 to 10 and Comparative Examples 1 and 2 was then compared, and the relative dielectric constants of the multilayer ceramic capacitors fired at temperatures of −20° C. and +20° C. were referenced from the multilayer ceramic capacitor obtained at the firing temperature with the highest resistivity. The slope of the straight line was found using the least squares method based on these firing temperatures and relative dielectric constants, and defined as the firing temperature dependency of the relative dielectric constant (Δε/° C.).

Furthermore, a conductive material of osmium was vapor-deposited onto the exposed dielectric layer, and the crystal grains present in the dielectric layer were photographed by SEM observation. The average grain size of the crystal grains constituting the dielectric layer was then calculated. The average grain size was 270 nm in Example 1, 260 nm in Example 2, 280 nm in Example 3, 280 nm in Example 4, 270 nm in Example 5, 280 nm in Example 6, 260 nm in Example 7, 270 nm in Example 8, 250 nm in Example 9, 240 nm in Example 10, 550 nm in Comparative Example 1, and 410 nm in Comparative Example 2.

In addition, during SEM observation of the multilayer ceramic capacitor, the presence of oxide 42 in the BSE image was confirmed by the difference in brightness.

Then, for each multilayer ceramic capacitor, in order to confirm the composition of the shell portion and the core portion of the crystal grains in the dielectric layer and the oxide 42, samples for EDS observation by TEM were cut out using FIB, and the presence of the core-shell structure was confirmed by the method of composition evaluation using EDS. The core portion was defined as a portion with an R/Ti element ratio of less than 0.02, and the shell portion was defined as a portion with the R/Ti element ratio of 0.02 or more and less than 0.20. In addition, the element ratio of the rare earth element R to titanium was also confirmed for the oxide 42, and it was confirmed that the R/Ti element ratio satisfied the requirement of 0.20 or more.

Furthermore, for each multilayer ceramic capacitor, the cover layer, the end margin, the side margin, and the external electrodes, which were not in the capacity section, were polished or cut off to separate them, and the dielectric layer constituting the capacity section was pulverized to obtain a powder. The diffraction line profile of the powder was measured using an X-ray diffraction device (XRD) using Cu-Kα radiation to confirm the presence of the oxide 42 that could be identified as R₂Ti₂O₇.

Table 1 summarizes the amounts of additives added in Comparative Examples 1 and 2 and Examples 1 to 10. Table 2 summarizes the firing temperatures, average grain diameters, F, Δε/° C., and resistivity at 150° C. in Comparative Examples 1 and 2 and Examples 1 to 10. The judgment was made as follows. The sample where Δε/° C. was 10 or less and resistivity was 1.0×10⁹ Ω·cm or more was judged as very good “∘”. The sample where Δε/° C. was 10 or less was judged as good “Δ”. The sample where Δε/° C. was more than 10 was judged as good “Δ”.

TABLE 1

| | ADDED AMOUNT TO 100 MOL OF BaTiO₂ (mol) | | | | | | | | | | | | | |
|---|---|---|---|---|---|---|---|---|---|---|---|---|---|---|
| | La₂O₂ | Pr₂O₃ | Nd₂O₂ | Eu₂O₃ | Gd₂O₂ | Dy₂O₃ | Ho₂O₃ | Er₂O₃ | Yb₂O₃ | Gd₂Ti₂O₂ | TiO₂ | MnCO₃ | SiO₂ | MgO |
| COMPARATIVE | 0.00 | 0.00 | 0.00 | 0.00 | 0.75 | 0.00 | 0.00 | 0.00 | 0.00 | 0.00 | 0.00 | 1.00 | 1.00 | 0.50 |
| EXAMPLE 1 | | | | | | | | | | | | | | |
| COMPARATIVE | 0.00 | 0.00 | 0.00 | 0.00 | 0.75 | 0.00 | 0.00 | 0.00 | 0.00 | 0.00 | 0.75 | 1.00 | 1.00 | 0.50 |
| EXAMPLE 2 | | | | | | | | | | | | | | |
| EXAMPLE 1 | 0.00 | 0.00 | 0.00 | 0.00 | 0.75 | 0.00 | 0.00 | 0.00 | 0.00 | 0.00 | 1.50 | 1.00 | 1.00 | 0.50 |
| EXAMPLE 2 | 0.75 | 0.00 | 0.00 | 0.00 | 0.00 | 0.00 | 0.00 | 0.00 | 0.00 | 0.00 | 1.50 | 1.00 | 1.00 | 0.50 |
| EXAMPLE 3 | 0.00 | 0.75 | 0.00 | 0.00 | 0.00 | 0.00 | 0.00 | 0.00 | 0.00 | 0.00 | 1.50 | 1.00 | 1.00 | 0.50 |
| EXAMPLE 4 | 0.00 | 0.00 | 0.75 | 0.00 | 0.00 | 0.00 | 0.00 | 0.00 | 0.00 | 0.00 | 1.50 | 1.00 | 1.00 | 0.50 |
| EXAMPLE 5 | 0.00 | 0.00 | 0.00 | 0.75 | 0.00 | 0.00 | 0.00 | 0.00 | 0.00 | 0.00 | 1.50 | 1.00 | 1.00 | 0.50 |
| EXAMPLE 6 | 0.00 | 0.00 | 0.00 | 0.00 | 0.00 | 0.75 | 0.00 | 0.00 | 0.00 | 0.00 | 1.50 | 1.00 | 1.00 | 0.50 |
| EXAMPLE 7 | 0.00 | 0.00 | 0.00 | 0.00 | 0.00 | 0.00 | 0.75 | 0.00 | 0.00 | 0.00 | 1.50 | 1.00 | 1.00 | 0.50 |
| EXAMPLE 8 | 0.00 | 0.00 | 0.00 | 0.00 | 0.00 | 0.00 | 0.00 | 0.00 | 0.00 | 0.75 | 0.00 | 1.00 | 1.00 | 0.50 |
| EXAMPLE 9 | 0.00 | 0.00 | 0.00 | 0.00 | 0.00 | 0.00 | 0.00 | 0.75 | 0.00 | 0.00 | 1.50 | 1.00 | 1.00 | 0.50 |
| EXAMPLE 10 | 0.00 | 0.00 | 0.00 | 0.00 | 0.00 | 0.00 | 0.00 | 0.00 | 0.75 | 0.00 | 1.50 | 1.00 | 1.00 | 0.50 |

TABLE 2

| | FIRING | AVERAGE | | | | |
|---|---|---|---|---|---|---|
| | TEMPER- | GRAIN | | | | |
| | ATURE | SIZE | | | RESISTIVITY | |
| | (° C.) | (nm) | ε | Δε/° C. | (Ω · cm) | JUDGE |
| COMPARATIVE | 1260 | 550 | 4500 | 15.5 | 1.9 × 10⁸ | X |
| EXAMPLE 1 | | | | | | |
| COMPARATIVE | 1250 | 410 | 3900 | 10.2 | 1.9 × 10⁸ | X |
| EXAMPLE 2 | | | | | | |
| EXAMPLE 1 | 1240 | 270 | 3320 | 6.1 | 2.6 × 10¹⁰ | ◯ |
| EXAMPLE 2 | 1220 | 260 | 2270 | 2.5 | 1.9 × 10⁸ | ◯ |
| EXAMPLE 3 | 1230 | 280 | 2470 | 2.7 | 5.2 × 10⁸ | ◯ |
| EXAMPLE 4 | 1230 | 280 | 2630 | 4.8 | 2.3 × 10⁹ | ◯ |
| EXAMPLE 5 | 1240 | 270 | 3080 | 5.1 | 3.9 × 10¹⁰ | ◯ |
| EXAMPLE 6 | 1240 | 280 | 3150 | 6.8 | 1.9 × 10¹⁰ | ◯ |
| EXAMPLE 7 | 1250 | 260 | 3020 | 5.5 | 5.6 × 10⁹ | ◯ |
| EXAMPLE 8 | 1240 | 270 | 3330 | 5.3 | 3.7 × 10¹⁰ | ◯ |
| EXAMPLE 9 | 1270 | 250 | 2200 | 2.7 | 5.1 × 10⁵ | Δ |
| EXAMPLE 10 | 1270 | 240 | 2150 | 2.3 | 5.1 × 10⁵ | Δ |

Comparative examples 1 and 2 were comparative examples in which gadolinium was contained as the rare earth element. In Comparative Examples 1 and 2, gadolinium was contained as the rare earth element, so that the average grain size was 550 nm and 410 nm, and the resistivity at 150° C. was 1.9×10⁸ Ωcm, and sufficient resistivity could be maintained. However, since there was not enough TiO₂ added, the value of Δε/° C. was greater than 10, and it was not possible to obtain the preferable value of 10 or less.

In Examples 1 to 7, 9, and 10, the amount of TiO₂ added was 1.5 mol per 100 mol of BaTiO₃, and lanthanum, praseodymium, neodymium, europium, gadolinium, dysprosium, holmium, erbium, and ytterbium were added as the rare earth element at 0.75 mol each. In Example 8, 0.75 mol of Gd₂Ti₂O₇ was added to 100 mol of BaTiO₃. In this composition, the value of Δε/° C. was 10 or less. For example, even when a larger sintering furnace than the existing one was used to increase productivity, the dielectric constant obtained with respect to the temperature distribution in the furnace, that is, the electrostatic capacity Cp value for a multilayer ceramic capacitor, did not have a large distribution. Therefore, even with sintering in a short time by rapid temperature rise, mass production is possible. In addition, when the rare earth element was europium, gadolinium, dysprosium, or holmium, “ε” was 3000 or more. In addition, the average grain size was 500 nm or less, and the resistivity was 1.0×10⁹ Ωcm or more.

In order to investigate the mechanism of the dielectric layer in detail, the following investigations were carried out by STEM-EDS on the multilayer ceramic capacitors obtained by the comparative examples 1 and 2 and examples 1 to 10: whether a core-shell structure exists, whether the oxide 42 exists, whether the element ratio “v” of Ba to Ti in the oxide 42 is in the range of v≤0.70, and whether the element ratio “w” of the rare earth element R to Ti is in the range of 0.40≤w. The results are summarized in Table 3.

TABLE 3

| | | | | | | CONTACT | |
|---|---|---|---|---|---|---|---|
| | | | | | | BETWEEN | |
| | SHELL | | CORE | | PRESENCE | CORES | OXIDE |
| | PORTION | | PORTION | | OF | AND | 42 |
| | R/Ti | Mn/Ti | R/Ti | Mn/Ti | OXIDE 42 | OXIDE 42 | R/Ti |
| COMPARATIVE | 0.061 | 0.020 | 0.006 | 0.001 | NONE | — | — |
| EXAMPLE 1 | | | | | | | |
| COMPARATIVE | 0.082 | 0.021 | 0.005 | 0.003 | NONE | — | — |
| EXAMPLE 2 | | | | | | | |
| EXAMPLE 1 | 0.101 | 0.017 | 0.003 | 0.003 | PRESENCE | NONE | 0.91 |
| EXAMPLE 2 | 0.085 | 0.022 | 0.008 | 0.002 | PRESENCE | NONE | 0.37 |
| EXAMPLE 3 | 0.097 | 0.018 | 0.007 | 0.004 | PRESENCE | NONE | 0.45 |
| EXAMPLE 4 | 0.102 | 0.025 | 0.007 | 0,002 | PRESENCE | NONE | 0.61 |
| EXAMPLE 5 | 0.117 | 0.012 | 0.003 | 0.001 | PRESENCE | NONE | 0.85 |
| EXAMPLE 6 | 0.098 | 0.016 | 0.004 | 0.002 | PRESENCE | NONE | 0.87 |
| EXAMPLE 7 | 0.081 | 0.021 | 0.003 | 0.004 | PRESENCE | NONE | 0.91 |
| EXAMPLE 8 | 0.092 | 0.017 | 0.003 | 0.002 | PRESENCE | NONE | 0.94 |
| EXAMPLE 9 | 0.079 | 0.018 | 0.002 | 0.001 | PRESENCE | CONTACT | 0.97 |
| EXAMPLE 10 | 0.072 | 0.015 | 0.004 | 0.002 | PRESENCE | CONTACT | 0.95 |

In Comparative Examples 1 and 2, the amount of TiO₂ added was insufficient, so the presence of the oxide 42, which is observed to be bright and relatively bright compared to the main crystal grains made of barium titanate in the SEM-BSE image, could not be confirmed.

On the other hand, in Examples 1 to 10, the element ratio “w” of the rare earth element R to Ti in the oxide 42 was in the range of 0.2≤w, so the presence of the oxide 42 was also clear. In addition, in Examples 1 to 8, the oxide 42 was not in contact with the cores of the grains.

Furthermore, as shown in Table 1, the value of Δε/° C. was 10 or less, the resistivity was 1.0×10⁸ Ω·cm or more, the average grain diameter was 500 nm or less, and the dielectric constant was ε>2000 or more. Therefore, even if a firing furnace larger than an existing firing furnace is used to increase productivity, the relative dielectric constant obtained with respect to the temperature distribution in the furnace, that is, the value of the electrostatic capacity Cp of the multilayer ceramic capacitor, does not have a large distribution. Therefore, even with firing in a short time by rapid temperature rise, mass production can be made possible, and sufficient reliability can be obtained.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
a dielectric layer that has a dielectric grain which includes a core portion, a shell portion surrounding the core portion and including a rare earth element, and an oxide segregated inside the shell portion and having a higher concentration of the rare earth element than the shell portion, and has a perovskite structure expressed by a general formula ABO₃;
a plurality of internal electrode layers that sandwich the dielectric layer and face each other; and
a plurality of external electrodes each of which is electrically coupled to each of the plurality of internal electrode layers.

2. The multilayer ceramic electronic device as claimed in claim 1, wherein the oxide includes a pyrochlore phase.

3. The multilayer ceramic electronic device as claimed in claim 1,
wherein an A site of the perovskite structure includes barium, and
wherein an element included in a B site of the perovskite structure is at least one of titanium or zirconium.

4. The multilayer ceramic electronic device as claimed in claim 1,
wherein the rare earth element is at least one of Lanthanum, cerium, praseodymium, neodymium, promethium, samarium, europium, gadolinium, terbium, dysprosium, holmium or erbium.

5. The multilayer ceramic electronic device as claimed in claim 1,
wherein an element ratio of the rare earth element to titanium is 0.02 or more and less than 0.20 in the shell portion.

6. The multilayer ceramic electronic device as claimed in claim 1,
wherein an element ratio of the rare earth element to titanium in the oxide is 0.20 or more.

7. The multilayer ceramic electronic device as claimed in claim 1,
wherein the oxide is enclosed in the shell portion.

8. The multilayer ceramic electronic device as claimed in claim 1,
wherein the oxide is in contact with a part of the core portion.

9. The multilayer ceramic electronic device as claimed in claim 1,
wherein the oxide is in contact with a part of a grain boundary of the dielectric grain.

10. The multilayer ceramic electronic device as claimed in claim 1,
wherein the oxide extends from a part of the core portion to a part of a grain boundary of the dielectric grain.

11. The multilayer ceramic electronic device as claimed in claim 1,
wherein the shell portion includes two or more of the oxide spacing from each other.

12. The multilayer ceramic electronic device as claimed in claim 1,
wherein the dielectric layer includes two or more of the dielectric grain adjacent to each other through a grain boundary, and
wherein the oxide does not connect core portions of the two or more of the dielectric grain.

13. The multilayer ceramic electronic device as claimed in claim 1, wherein the oxide is not in contact with the core portion.

14. The multilayer ceramic electronic device as claimed in claim 1,
wherein the dielectric layer includes two or more of the dielectric grain, and
wherein a maximum grain diameter of the two or more of the dielectric grain is 2 μm or less.

15. The multilayer ceramic electronic device as claimed in claim 1,
wherein the shell portion includes magnesium and manganese.

16. A dielectric ceramic composition comprising:
a dielectric grain which includes a core portion, a shell portion surrounding the core portion and including a rare earth element, and an oxide segregated inside the shell portion and having a higher concentration of the rare earth element than the shell portion, and has a perovskite structure expressed by a general formula ABO₃.
